(19) United States
(12) Patent Application Publication
(10) Pub. No.: US 2024/0090515 A1
(43) Pub. Date: Mar. 21, 2024

(54) MILK BISCUIT

(71) Applicant: SAVENCIA SA, Viroflay (FR)

(72) Inventors: Anne-Claire DA SILVA BOUCHER, Orcemont (FR); Peter MALKUS, Dolny Hricov (SK); Pierre AYMARD, Antony (FR); Pierre LACOTTE, Paris (FR); Virginie PADEL, Favieres (FR)

(73) Assignee: SAVENCIA SA, Viroflay (FR)

(21) Appl. No.: 17/768,175

(22) PCT Filed: Oct. 13, 2020
(86) PCT No.: PCT/EP2020/078714

§ 371 Date: Apr. 11, 2022

(30) Foreign Application Priority Data
Oct. 18, 2019 (EP) 19306359.1

(51) Int. Cl. A21D 13/80; A21D 2/18; A21D 2/26; A21D 13/22

(52) U.S. Cl. CPC A21D 13/80; A21D 2/181; A21D 2/263; A21D 13/22

(57) ABSTRACT

A food product of the milk biscuit type mainly constituted of milk ingredients having organoleptic qualities, in particular crunchiness and puffiness, of a biscuit, where the milk biscuit includes 30 to 60% by weight of the total weight of the milk biscuit of proteins, of which at least 80% is of milk origin, 12 to 45% by weight of the total weight of the milk biscuit of mono- and/or disaccharides, of which at least 60% by weight of said mono- and/or disaccharides is lactose, 1 to 40% by weight of the total weight of the milk biscuit of lipids; and less than 6% by weight of the total weight of the milk biscuit of water.

The present invention relates to the field of the food industry; it more specifically relates to a milk biscuit and its manufacturing method.

Indeed, the Applicant has developed food products, of which the appearance, the texture and the organoleptic properties are those of a biscuit, while these products are mainly constituted of milk ingredients.

Biscuits are cereal products developed from flour, fats and sugars, having a low residual humidity (less than 5% by weight).

More specifically, biscuits are generally composed mainly of flour (15 to 75% by weight), most often wheat, fats (10 to 50% by weight) and sugars (5 to 50% by weight). According to the balance between flour, sugars and fats, on the one hand, and the hydration level of dough on the other hand, several types of dough are distinguished:
Hard or semi-hard doughs comprise at least 50% of flour, have a cohesive and continuous structure with a firm and plastic rheology. They are often rolled into thin layers before being roto-cut into individual pieces of dough which are then cooked.
“Fatty” doughs have a flour content comprised between 25% and 60% and higher sugar and fat contents (15 to 40%). When the hydration level is low, the dough has a sandy appearance with a non-cohesive and brittle structure. It is customary to compress the dough, most often in a rotary moulding machine, to obtain a piece of dough which can be manipulated which is then cooked. At a greater hydration, the piece of dough find a continuous structure, but a structure which is a lot more flexible than hard and semi-hard doughs. The dough can be pushed in a cylinder (which resembles a low shearing extrusion) followed by cutting the dough, typically using a wire cutter. The piece of dough is generally deposited on a solid band on which it will be spread more or less during cooking.

Other ingredients are also used in biscuit-making, like baking powders or emulsifiers. Despite their incorporation at a low content in the biscuit dough, they have an essential role on the quality of the doughs and end products and are vital for their production.

Baking powders are substances or combination of substances which release gases within the dough during cooking and contribute to its expansion. An example of substance is ammonium bicarbonate which is broken down with heat in carbon dioxide and ammoniac without leaving any residue. An example of combination is the mixture of a base (of carbonate or bicarbonate type) and of a weak acid (of tartaric or sodium pyrophosphate acid type), mixture which generates carbon dioxide in the presence of water and heat.

Emulsifiers are surfactant compounds conventionally used in biscuit-making. They have different roles: on the technological level, they facilitate the dispersion of fats during kneading, increasing the stability of the dough during rest time and improve its machinability during forming. They also have a positive impact on the appearance of the end product and its conservation over time (potential slowing of oxidation and of regression of starch).

Milk ingredients like milk powder or soft whey are sometimes added to the biscuit formulations in small doses (less than 2% by weight of the dough) to apply colour and flavours via the Maillard reaction, initiated by the interaction between the milk proteins and the reducing sugars. With larger doses, the milk powders or soft whey tend to strongly colour the biscuits and to give hard and compact textures, which are not liked by consumers.

The nutritional profile of the biscuits has formed the subject of much improvement work, aiming in particular to reduce the fat and sugar contents and to increase the fibre and protein content. The use of proteins having a high lysin content, like milk proteins or leguminous proteins is particularly interesting from a nutritional standpoint as lysin is an essential amino acid, which is lacking in wheat and cereals, generally. However, the enrichment in proteins have proved to be, in most cases, unfavourable for the technological properties of the dough and for the organoleptic properties of the biscuits. The effect is all the more marked, that the protein content incorporated is high. The incorporation of proteins generally requires an increase of the hydration of the dough due to their high capacity to retain water. The dough becomes unstable during rest time and difficult to form, which decreases the yield. The cooking conditions (time and/or temperature) must also be modified in order to evaporate the additional water added to the kneading. The texturing effect of the proteins in the dough strongly penalises the development and denser and harder products are obtained. The increase of hardness is also accentuated when the proteins gel during cooking, thus reinforcing the hardness of the biscuit matrix, due to the combination of sugar vitrification phenomena, insolubilisation of wheat proteins and partial puffing or gelatinisation of starch.

These technical limitations probably explain why there is not biscuit-type product both rich in milk and rich in proteins, having an aerated structure and a crunchy texture. The products enriched in proteins are presented most often in the form of:
dry and crunchy bars obtained by incorporating particles extruded in a sugary and fat binder, containing emulsifiers. The inclusions extruded are mixed with the hot binder to obtain a flexible dough, which is spread into sheets then cooled in order to harden and finally cut into bar shapes. There is no actual cooking, only possibly a drying, which does not allow to obtain the flavour profile of cooked products. The texture in the mouth is close to “breakfast” cereals (“Ready To Eat Cereals”) and the appearance of the bar, very heterogenic, is very different from that of a biscuit which is generally smoother and continuous.
bars having a “chewy” texture and containing proteins in the form of powders and inclusions extruded. The chewy texture is due to a greater residual humidity in the end product (greater than 10%), which is a technical solution to the increase of hardness linked to the incorporation of proteins. These bars contain a significant number of additives, such as baking powders, emulsifiers, but also humectants and thickeners. Thus, application EP 3531837 A1 (Générale Biscuit) describes a cooked cereal product having a chewy texture and containing between 20% and 30% of proteins added in the form of powder or of solid particles. The proportion of milk proteins represents between 0 and 16% of the proteins added in the form of powder and between 33 and 50% of proteins added in particle form. Given the proportions between proteins in the form of powder and in the form of particles indicated in the claims, it can therefore be estimated that the end product contains between 0 and 14% of milk proteins. It also contains cereal ingredients (flour and cereal inclusions), sugars, egg powder, baking powders, emulsifiers, a humectant. The water content is comprised between 8 and 16% and the densities between 0.6 and 0.92 g/cm³.

The presence of additives is less and less accepted by consumers who seek natural and slightly transformed products. Moreover, the products of this category have a form (rather rectangular and thick), a surface appearance (heterogenic) and a texture in the mouth, different from those of biscuits.

A certain number of patents describe dry and crunchy compositions containing increased protein contents.

US2003091698 A1 (Marsland) rightly mentions that biscuit-making methods have been, on the whole, designed and adapted for formulations rich in amylase compounds. This poses, according to the inventors, public health problems such as obesity, diabetes, irritable bowel syndrome, etc. The solution proposed is to replace the amylase compounds by wheat proteins and other proteins, so as to obtain an extendible, pliable dough, which can then be rolled, cut then dried using a frying, oven-cooking, microwave cooking method, etc. until reaching the target residual humidity. The end product contains at least 25% of proteins by weight. The wheat proteins are known for their marked viscoelastic properties and such a level of incorporation would have generated a very elastic dough and dough which is impossible to form and cut. In fact, the inventors propose to integrate in the formulation, wheat proteins modified by reducing chemical agents which have the effect of cleaving disulphide bridges and to lose the viscoelastic effect.

Another example is GB 1500012A (Chiari & Forti SPA) which wants to obtain biscuits having a protein content of the order of 13% to 15% by conserving the sensorial properties of standard products (which contain less than 8% of proteins) and avoiding resorting to expensive ingredients such as protein concentrates or isolates. The Applicants propose using a flour with high protein content, obtained by a physical method allowing a partial separation of starch and proteins. The flour thus treated has a protein content of the order of 18 to 22%. However, it is also known that biscuits generated from such flours have an irregular form and an excessively hard texture. This is linked to the specific properties of gluten, main protein of wheat. The solution highlighted therefore consists of using this flour enriched in proteins by combining it with technological correctors such as proteolytic enzymes, or also reducing agents such as cysteine.

US2003064145 A1 (Fannon) reproaches gluten for being a source of food intolerances, for having a limited nutritional value and insists on the necessity to obtain a snack having good sensorial properties, a limited fat content and a high protein content having a positive impact on health. The technical solution proposed in response to these different disadvantages consists of using soya proteins, a fraction of which is hydrolysed, cereal proteins, an amylase agent (of flour or rice or tapioca starch type), a plasticiser (water and/or polyol). The powders are hydrated then the mixture is extruded using an extruder cooker, before being cut, dried, flavoured then packaged. The products have a protein content comprised between 25% and 95% by weight of dry material, a fat content comprised between 0.2% and 30% by weight of dry material and a ratio between starch and protein content comprised between 5:95 and 75:25, which corresponds to a starch content comprised between 1.2% and 71.2% by weight. A specificity of the food product described is that the extruded mixture must not contain more than 0.5% of fat, the remainder of the fat being applied to the surface of the product after extrusion. The inventors give no explanation to this, but it is known to a person skilled in the art that the compositions rich in fats cannot be extruded as the fat induces phenomena of sliding in the screw of the extruder, which disrupt the extrusion process by decreasing the actual shearing perceived. The fact that the fat is only at the periphery of the product allows to avoid the problem, but can however contribute to giving an oily perception to the touch and a fatty taste in the mouth, making the product not very attractive for the consumer.

Another approach for obtaining snacks enriched in proteins and low in gluten by extrusion is that described by Licker et al. (WO 2009/129024 A2, Frito-Lay). The inventors describe that the enrichment in proteins in extruded snacks generates different types of problems, such as excessive colouring, taste and undesirable flavour compounds, as well as expansion problems of the snack. The technical solutions retained by the inventors consist of using milk protein isolates, i.e. milk ingredients of which lactose has been removed almost totally. These ingredients (calcium caseinate, serum protein isolate and milk protein isolate) contain at least 90% of proteins. Formulations using one or the other of these milk ingredients, as well as significant quantities of starch (between 32 and 66%) and optionally emulsifiers allowing to obtain expanded snacks comprising 18% of proteins (5 g per 28 g portion).

Other applications also mention resorting to specific milk ingredients to resolve the technical problems that the enrichment in protein in cereal products poses. In the case of application US 2019/0059396 A1 (Smith Tucker), the Applicant wants to enrich a cookie dough in proteins with milk serum proteins, but their incorporation is limited as they make doughs sticky and difficult to manipulate and the end products have an unpleasant rubbery texture. The solution proposed is to use a specific grade of concentrate of serum proteins which is referenced WPPC for “Whey Protein Phospholipid Concentrate” which comes from a very specific fraction obtained by membrane treatments and contains at least 12% of fat, including membrane lipids, i.e. membrane lipids of milk fat globules. These lipids have been described as having properties close to egg yolk, which would allow, according to the Applicants, to obtain a cookie dough having adequate machinability and, after cooking, cookies close to the referent. The formulations of cookie doughs described also contain numerous other ingredients such as sugars (saccharose and syrups), fats, milk proteins, baking powders, sweeteners (sucralose), polyols (glycerol and sorbitol), food fibre syrup, apple syrup, chocolate chips, flavours and optionally egg.

Other applications also state the interest of original protein materials: application CN 107691562A (Zhenglanqi Changhong Dairy Products Factory) mentions the use of mixtures of “milk co-products” such as buttermilk and serum proteins, in the form of serums or in the form of Ricotta-type cheese. The aim is to enhance these milk materials by mixing them with flour, eggs, sugar, optionally other milk proteins to make doughs from them which can then be cooked. The doughs contain typically 33 to 37% of buttermilk, 28 to 32% of serum cheeses, 16 to 20% of wheat flour, 5 to 7% of brown sugar, 4 to 6% of skimmed milk powder, 2 to 4% of refined sugar and 2 to 4% of eggs.

Application CN 104 855 465 A (Xinjiang Wangyuan Camel Milk Ind Co Ltd) uses another specific ingredient which is camel milk. This milk has nutritional properties and useful health benefits, but the production is limited and the cost high, which has incited the Applicants to mix this milk, in liquid or powder form, with other ingredients such as sweet potato flours, konjac, hawthorn and lotus leaves, to make a nutritional product from it. The camel milk powder contents calculated in Examples 1 to 9 are comprised between 3.7 and 19% of the total weigh of the biscuit. The proportion of milk ingredients (also including butter) is comprised between 5 and 20%.

Application WO 2016/116426 (ProteiFood) relates to a long-life biscuit- or waffle-type food product, without cereal flour and offering a protein and mineral salt content necessary for children, adults, sportspeople and elderly people. The application relates to a dry expanded food product comprising at least the following ingredients: a protein concentrate of animal or plant origin, a fat, a texturing additive—selected from among the group constituted of hydrocolloids and plant gellants, proteolytic additives and their hydrolysis products, acidifying agents and their salts, maltodextrin—and residual water. The principle of the invention consists either of mixing the protein concentrate and the fat (with optionally other ingredients) with a gellant (of hydrocolloid type, like carrageenan, agar, etc. or also starch type, preferably modified), or of treating the protein concentrate with a proteolytic agent (of rennet type, in particular) and/or an acidifying agent (ferments or chemical acidifier) in order to result in a coagulation of said protein concentrate. These two treatments are carried out under time-temperature-shearing operating conditions known to a person skilled in the art. In both cases, the aim is, at the end of a certain rest time, to obtain a gelled solid having a sufficiently firm rheology to be sliced or grated, operation optionally preceded by a partial drying phase. Finally, the last expansion step is carried out using a microwave oven.

Application WO 2018/019954 (ProteiFood), from the same inventors as application WO 2016/116426, is distinguished from it by the absence of texturing additive and fat. The invention also relates to a method for manufacturing a dry expanded food product constituted of or comprising a protein concentrate of animal or plant origin, of food grade and of residual water. The manufacturing method consists of preparing a heat-expandible precursor constituted of or comprising a protein concentrate of animal or plant origin and water, at a temperature comprised between 4° C. and 100° C. and to subject the heat-expandible precursor to heat, in a microwave-type device, to cause its expansion and the reduction of water content to a residual content.

The inventors indicate that the heat-expandible precursor contains preferably between 15% and 50%, preferably between 20% and 40%, by weight of proteins, but not specifying if other ingredients are added, or if the complement is constituted of added water. Only the residual water content in the end product is specified (between 3% and 10%). The heat-expandible precursor obtained, in the form of dough or gel, is optionally detailed in pieces, according to the desired form and size of the expanded food product. The compositions of end products detailed in the Table summarising recipes indicates protein contents comprised between 40% and 59%, fat contents comprised between 19% and 30% and a sugar content comprised between 1.3% and less than 10%. It must be noted that Examples 3 to 5 comprise Fibruline, commercial name of the inulin produced by the supplier Cosucra in Belgium. Inulin is a food fibre and is not considered as a digestible carbohydrate such as milk lactose or saccharose. In the following table on page 46, Examples 2 and 6 comprise a DE (Dextrose Equivalent) Maltodextrin equal to 10. It is known that the content of mono- and disaccharides of DE maltodextrins 10 is less than 10% of the total mass of the ingredient, the remainder being composed of molecules having a degree of polymerisation DP at least equal to 3. The content of mono- and disaccharides in all the examples remains therefore less than 10% in all the cases.

All of the state of the art shows that numerous attempts of an expanded and crunchy snack, rich in proteins, have been proposed. There are certain analogies between these applications. In terms of nutritional composition, the compositions comprise a high protein content, but these are more often plant proteins than milk proteins. In addition, when these are milk proteins, the Applicants preferably select protein concentrates or isolates, i.e. purified ingredients, wherein the undesirable compounds have been removed. By undesirable compound, this means compounds which have a low technological functionality and decrease the efficiency of the manufacturing method, while diluting the protein content. Lactose can be considered as such in dry products, due to its very limited solubility. In addition, through its reducing character, lactose reacts with proteins during cooking (Maillard reaction) which generates a marked brown colouring, even a taste or burnt flavour notes which are undesirable. Designing a product both rich in proteins and in lactose is therefore not recommended by the prior art, the authors mentioned above choosing concentrated proteins containing as less as possible lactose.

A means of avoiding these technological problems has been proposed in application FR 2 237 401 A5 (Klosterfrau Berlin Chem). This application aims to manufacture so-called diet biscuits with a high milk protein content and low fat and sugar contents. Proteins comes from skimmed milk, which has been dialysed beforehand to reduce the sugar content then dried, and plant proteins such as wheat or soya. These powders are incorporated in an anhydrous phase composed of fat and lecithin at a temperature less than 65° C. and the dough obtained is deposited in moulds and cooled until it is quite hard to be manipulated. It is important to note that the manufacturing of this food product does not comprise any cooking step, the product obtained is therefore not a biscuit; the latter has a density comprised between 0.75 and 0.9 g/cm³ and has a hard and brittle texture: it is necessary to bite the product vigorously to detach pieces from it. The proportion of milk ingredients in the end product is comprised between 14% and 57%. Finally, the type of composition proposed therefore more resembles an anhydrous bar, of the type similar to white chocolate than to a biscuit stricto sensu.

Logically, the prior art proposes the implementation of ingredients having high protein contents in order to succeed in producing expanded snacks, rich in protein. However, in this context, powdered skimmed milk, comprising about 34% of proteins and more than 50% of lactose, has never been incorporated in these expanded snacks, due to its relatively low protein content and its high lactose content.

It is also common to find amylase compounds of the flour or starch type, of which the texturing and expansion role in a cooking-type heat treatment is well-known. By amylase compound, this means any raw material or ingredient comprising at least 60% of starch by weight, which includes different cereal, leguminous, pseudo-cereal flours, as well as purified starches, obtained after separation of the protein fraction present in flours. Starches are themselves composed of two types of molecules in a variable proportion (amylose and amylopectin) organised in so-called pseudo-crystalline complex particles, i.e. partially crystalline and partially amorphous. In the native state, starch is presented in the form of granules of the order of one micron to ten microns integrated in tissues (cereal endosperm, for example) present in numerous botanic species, wherein it constitutes an energy reserve. The most common amylase compound sources are cereal flours and in particular, wheat. Other alternatives are used such as: other cereal flours, refined or complete: rice, maize, oat, barley, spelt, small spelt, einkorn, triticale, etc, pseudo-cereal flours (quinoa, amaranth and buckwheat) or leguminous (peas, lentils, beans, chickpeas). Starches and flours can be subjected to physical, enzymatic and/or chemical treatments which modify their technological properties, in particular solubility and texturing power. As an example, maltodextrins are hydrolysed starches enzymatically or chemically which have intermediate properties between those of complex carbohydrates and simple carbohydrates and which are used in the formulation of certain biscuits.

Other ingredients used in biscuit-making contain starch contents less than 60%: this is, for example, certain leguminous flours (peas, lentils, chickpeas, beans, etc.) or optionally turbo-separated cereals, cereal brans, aleurone-type cereal fractions, and cereal or leguminous food fibres. Other food fibres can also be used. These are carbohydrate compounds of degree of polymerisation (DP) greater than or equal to 3 and non-metabolised nor digested in the small intestine. Food fibres are either naturally present in food (vegetable fibres, fruits, cereals, etc.), or obtained from edible raw materials by physical, enzymatic or chemical modification (fructo-oligosaccharides, resistant dextrins, resistant starches, etc.) or also obtained by synthesis (polydextrose). Conventionally, fibres are distinguished according to their solubility and their texturing character. Short-chain soluble fibres are soluble, non-texturing and can be used in a high dosage to reduce the sugar content of biscuit products. Insoluble fibres are more or less texturing according to the puffing or water retention capacity, itself according to the size and to the morphology of the particles. These insoluble fibres are conventionally used to improve the mechanical resistance of biscuits, but usually at lower doses (a few percent by mass).

The use of these compounds (starches and derivatives, fibres, polyols, etc.) is often associated with the use of additives conventionally used in biscuit-making, such as emulsifiers or leavening agents.

To conclude, on the one hand, approaches can be distinguished which can take, as the starting point, the reference biscuit creation and replace some of the amylase compounds and/or sugars with proteins, while conserving a sufficient content to guarantee the expansion and by bolstering conventional additives such as emulsifiers and leavening agents. Another approach consists of implementing selected protein concentrates and texturing them using gellants or coagulating them so as to have a firm and solid dough which can be cut then dried.

In both cases, the expansion method generally selected in the state of the art is extrusion, well-known to a person skilled in the art to very strongly compress the dough inside the heated sleeve of the extruder and actually generate a strong expansion exiting the extruder, which drastically vaporises the water contained in the formula and generates a high expansion. An alternative is the use of a microwave system as in application WO 2018/019954. The technologies mentioned in the prior art (including extrusion and microwave) do not form part of conventional biscuit-making technologies, which are a string of simple operations, carried out at atmospheric pressure: kneading to obtain a dough (either cohesive or dispersed), forming to obtain an individual piece of dough then cooking (generally, in a direct or forced convection oven) to obtain the desired level of residual humidity.

In this context, the Applicant gave as the aim, the development of a milk biscuit mainly constituted of milk ingredients and with no additives conventionally used in biscuit-making; the obtaining of a biscuit-type texture from mainly milk ingredients is surprising as, this has been detailed above, it is known to a person skilled in the art that the incorporation of milk ingredients is unfavourable for the preparation of a quality biscuit. Further to the negative impact of the proteins mentioned above, lactose also poses technological and organoleptic problems. It is indeed ten times less soluble than saccharose, which highly limits its dissolution in doughs during kneading and forming phases. Therefore, it does not allow to decrease the hydration of doughs, which saccharose conventionally allows, and can also give a sandy character in the mouth. The sugary flavour of the lactose is also a lot weaker than that of saccharose which is not liked by consumers. It is therefore by overcoming these prejudices that the Applicant has developed the milk biscuit which is the subject matter of the present invention which comprises:
30 to 60% by weight of the total weight of the milk biscuit of proteins, of which at least 80% is of milk origin;
   In particular, the ponderal protein content with respect to the total weight of the milk biscuit can be comprised between 30 and 50%, between 30 and 40% between 35 and 50%, between 35 and 40%, between 40 and 50%, between 40 and 45% or between 50 and 60%; preferably, this content is comprised between 30 and 50%, between 30 and 40%, between 35 and 50% or between 35 and 40%, and more preferably between 30 and 50% or between 30 and 40%; and the ponderal milk protein content with respect to the total weight of the proteins is, in the order of the preferred content to the most preferred protein, of at least 85%, at least 90%, at least 95%, at least 98% or 100%.
12 to 45% by weight of the total weight of the milk biscuit of mono- and/or disaccharides, of which at least 60% by weight of said mono- and/or disaccharides is lactose;
   In particular, the ponderal content of mono- and/or disaccharides with respect to the total weight of the milk biscuit can be comprised between 12 and 30%, between 20 and 45%, between 30 and 45%, between 35 and 45%, between 20 and 35% or between 20 and 30%; preferably, this content is comprised between 30 and 45% or between 35 and 45%, and more preferably, it is comprised between 35 and 45%; and the ponderal lactose content with respect to the total weight of the mono- and/or disaccharides is, in the order of the preferred content to the most preferred content, selected from among at least 70%, at least 80%, at least 90%, at least 95%, 100%;
1 to 40% by weight of the total weight of the milk biscuit of lipids;
   In particular, the ponderal lipid content with respect to the total weight of the milk biscuit is comprised between 1 and 10%, between 1 and 5%, between 1 and 2%, between 10 and 40%, between 10 and 30%, between 10 and 25% or between 15 and 25%;
less than 6%, preferably less than 5%, more preferably less than 4%, totally preferably 3% or less, by weight of the total weight of the milk biscuit of water.

Preferably, said biscuit is furthermore, such that:
it comprises at least 60% by weight of the total weight of the milk biscuit of ingredients of milk origin; the ponderal content of ingredients of milk origin with respect to the total weight of the milk biscuit is, in the order of the preferred content to the most preferred content, selected from among at least 70%, at least 80%, at least 90%, at least 95%; according to a particular embodiment, the milk biscuit only contains milk ingredients which thus represent 100% of the dry weight of the milk biscuit; and/or
it has an apparent density comprised between 0.1 and 0.6 g/cm³; the apparent density is, in the order of the preferred value to the most preferred value, comprised between 0.1 and 0.5 g/cm³; 0.1 and 0.4 g/cm³ and 0.1 and 0.3 g/cm³; and/or
it comprises less than 10% by weight of the total weight of the milk biscuit of compounds other than those listed above, i.e. proteins, mono- and/or disaccharides, lipids and water; the ponderal content of other compounds with respect to the total weight of the milk biscuit is, in the order of the preferred content to the most preferred content, selected from among less than 5%, less than 3%, less than 2%, less than 1% and 0%; and/or
it comprises less than 1%, preferably less than 0.5%, more preferably less than 0.25% and totally preferably 0%, by weight of the total weight of the milk biscuit of at least one additive selected from among baking powders and emulsifiers.

By “compounds other than those listed”, the following can be mentioned:
amylase compounds, i.e. a raw material or an ingredient comprising at least 60% of starch by weight, which includes different cereal flours (wheat, oat, rice, maize, barley, etc.), leguminous flours (peas, lentils, chickpeas, broad beans, beans, etc.), pseudo-cereal flours (buckwheat, quinoa, amaranth), as well as purified starches, obtained after separation of the protein fraction present in flours and optionally modified physically, enzymatically or chemically, such as maltodextrins;
minor starch sources, comprising less than 60% of starch by weight, which includes certain cereal, leguminous, pseudo-cereal, native flours, or flours potentially subjected to a physical separation treatment in order to reduce its starch content;
food fibres, such as chicory fibres (inulin), optionally partially hydrolysed (fructooligosaccharides or FOS), resistant dextrins, polydextrose, cereal brans, insoluble cereal or leguminous fibres, resistant starches, etc.; and/or
polyol sources (maltitol, glycerol, sorbitol, etc.) or intense sweeteners, of any oligoelement vitamin source, minerals added in the more or less purified form.

The present invention therefore relates to a milk biscuit constituted of:
30 to 60% by weight of the total weight of the milk biscuit of proteins, of which at least 80% is of milk origin;
   In particular, the ponderal protein content with respect to the total weight of the milk biscuit can be comprised between 30 and 50%, between 30 and 40%, between 35 and 50%, between 35 and 40%, between 40 and 50%, between 40 and 45%, or between 50 and 60%; preferably, this content is comprised between 30 and 50%, between 30 and 40%, between 35 and 50% or between 35 and 40%, and more preferably between 30 and 50% or between 30 and 40%; and the ponderal milk protein content with respect to the total weight of the proteins is, in the order of the preferred content to the most preferred content, of at least 85%, at least 90%, at least 95%, at least 98% or 100%.
12 to 45% by weight of the total weight of the milk biscuit of mono- and/or disaccharides, of which at least 60% by weight of said mono- and/or disaccharides is lactose;
   In particular, the ponderal content of mono- and/or disaccharides with respect to the total weight of the milk biscuit can be comprised between 12 and 30%, between 20 and 45%, between 30 and 45%, between 35 and 45%, between 20 and 35% or between 20 and 30%; preferably, this content is comprised between 30 and 45% or between 35 and 45%, and more preferably, it is comprised between 35 and 45%; and the ponderal lactose content with respect to the total weight of mono- and/or disaccharides is, in the order of the preferred content to the most preferred content, selected from among at least 70%, at least 80%, at least 90%, at least 95%, 100%;
1 to 40% by weight of the total weight of the milk biscuit of lipids;
   In particular, the ponderal lipid content with respect to the total weight of the milk biscuit is comprised between 1 and 10%, between 1 and 5%, between 1 and 2%, between 10 and 40%, between 10 and 30%, between 10 and 25% or between 15 and 25%;
less than 6%, preferably less than 5%, more preferably less than 4%, totally preferably 3% or less, by weight of the total weight of the milk biscuit, of water.

According to this embodiment, said biscuit is furthermore preferably such that:
it comprises at least 60% by weight of the total weight of the milk biscuit of ingredients of milk origin; and/or
it has an apparent density comprised between 0.1 and 0.6 g/cm³ .

The table below illustrates the composition of various embodiments of the milk biscuit according to the invention:

| Embodiments | 1 | 2 | 3 | 4 | 5 | 6 |
|---|---|---|---|---|---|---|
| % by weight of | 30 to 50% | 30 to 40% | 30 to 50% | 50 to 60% | 30 to 40% | 30 to 40% |
| proteins with respect | | | | | | |
| to the total weight of | | | | | | |
| the milk biscuit | | | | | | |
| % by weight of | At least | At least | At least | At least | At least | At least |
| proteins of milk origin | 85% | 98% | 95% | 95% | 95% | 85% |
| with respect to the | | | | | | |
| total weight of proteins | | | | | | |
| % by weight of mono- | 30 to 45% | 35 to 45% | 12 to 30% | 30 to 45% | 35 to 45% | 30 to 45% |
| and disaccharides with | | | | | | |
| respect to the total | | | | | | |
| weight of the milk | | | | | | |
| biscuit | | | | | | |
| Ponderal lactose | At least | At least | At least | At least | At least | At least |
| proportion with | 70% | 95% | 95% | 95% | 60% | 60% |
| respect to the mono- | | | | | | |
| and disaccharides | | | | | | |
| % by weight of lipids | 10 to 30% | 10 to 25% | 10 to 30% | 1 to 10% | 10 to 30% | 10 to 30% |
| with respect to the | | | | | | |
| total weight of the | | | | | | |
| milk biscuit | | | | | | |

Furthermore, according to each of these embodiments,
the biscuit according to the invention can be such that:

| | | | | | | |
|---|---|---|---|---|---|---|
| Water content (by | Less than | Less than | Less than | Less than | Less than | Less than |
| weight with respect to | 4% | or equal | 4% | 4% | or equal | 4% |
| the total weight of the | | to 3% | | | to 3% | |
| milk biscuit) | | | | | | |
| % by weight of milk | At least | At least | At least | At least | At least | At least |
| ingredients with | 80% | 85% | 95% | 95% | 60% | 60% |
| respect to the dry | | | | | | |
| weight of the milk | | | | | | |
| biscuit | | | | | | |
| Apparent | 0.1 and | 0.1 and | 0.1 and | 0.1 to | 0.1 to | 0.1 to |
| density (g/cm³) | 0.4 | 0.3 | 0.4 | 0.4 | 0.4 | 0.4 |

According to an embodiment, the milk biscuit according to the invention comprises:
30 to 50% by weight of the total weight of the milk biscuit of proteins, of which at least 80% is of milk origin;
12 to 45% by weight of the total weight of the milk biscuit of mono- and/or disaccharides, of which at least 60% by weight of said mono- and/or disaccharides is lactose;
2 to 40% by weight of the total weight of the milk biscuit of lipids;
less than 6% by weight of the total weight of the milk biscuit of water; said biscuit is such that
it comprises at least 60% by weight of the total weight of the milk biscuit of ingredients of milk origin;
it has an apparent density comprised between 0.1 and 0.6 g/cm³; and
it comprises less than 10% by weight of the total weight of the milk biscuit of amylase compound; and
it comprises less than 1% by weight of the total weight of the milk biscuit of at least one additive selected from among baking powders and emulsifiers.

Surprisingly, such a recipe, mainly constituted of milk ingredients allows the preparation of food product of the crunchy biscuit type with a marked puffing by implementing conventional and economic biscuit-making industrial methods, such as so-called rolling and “rotary moulding” methods, which comprises a kneading phase, a dough piece forming phase (by rolling the dough into a thin layer or by moulding the dough using a rotary moulding machine), then cooking pieces of dough and packaging the end products.

According to a method of the invention, the recipe of the milk biscuit according to the invention has no compound other than those listed, i.e. proteins, mono- and/or disaccharides, lipids and water, and of any additive of the baking powder or emulsifier type used during the manufacturing of biscuits; in particular, the recipe has no:
amylase compound, i.e. of raw material or ingredient comprising at least 60% of starch by weight, which includes different cereal flours (wheat, oat, rice, maize, barley, etc.), leguminous flours (peas, lentils, chickpeas, broad beans, beans, etc.), pseudo-cereal flours (buckwheat, quinoa, amaranth), as well as purified starches, obtained after separation of the protein fraction present in flours and optionally modified physically, enzymatically or chemically such as maltodextrins;
minor starch source, comprising at least 60% of starch by weight, which also includes cereal, leguminous, pseudo-cereal, native flours, or flours potentially subjected to a physical separation treatment in order to reduce its starch content;
food fibre source, such as chicory fibres (inulin), optionally partially hydrolysed (fructooligosaccharides or FOS), resistant dextrins, polydextrose, cereal brans, insoluble cereal or leguminous fibres, resistant starches, etc.; and
polyol source (maltitol, glycerol, sorbitol, etc.) or intense sweeteners, oligoelement vitamin source, minerals added in the more or less purified form.

The ingredients of milk origin, whether these are proteins, lipids, mono- and disaccharides or also calcium, can come from milk derivative products such as whole milk, partially or totally skimmed milk, totally or partially skimmed milk powder, milk protein powder, fermented milk, fat material, cream, butter, any type of cheese, etc. These ingredients have a well-known nutritional interest, going from the quality of the proteins (considered as reference proteins, with a balanced profile of amino acids and a high digestibility) to the mineral content, such as calcium.

A person skilled in the art will know how to consider the nutritional composition of these milk derivative products to comply with the composition of the milk biscuit.

Usually, proteins of milk origin comprise two protein families: caseins, high-abundant milk proteins (80% by mass of milk proteins) and serum proteins (20% by mass of milk proteins), mainly β-lactoglobulin and α-lactalbumin.

The milk biscuit according to the invention can also comprise proteins of non-milk origin like proteins of plant origin and in particular proteins coming from cereals (wheat, oat, rice, maize, barley, etc.), pseudo-cereals (quinoa, amaranth, buckwheat), leguminous (peas, lentils, chickpeas, broad beans, beans, etc.), oilseed/protein (soya) and oleaginous (dry fruits and seeds such as colza, sunflower, flax, sesame, chia, etc.).

By lipid, this means a fat of milk or plant origin, or their mixture; in the case of using a vegetable fat, it will preferably be oils such as colza, sunflower, oilseed sunflower, olive oils, etc. or concrete to semi-concrete fats such as cocoa butter, shea butter, palm, palm kernel, copra, etc.

Conventionally, the mono- and disaccharides are simple sugars such as glucose, fructose, galactose, maltose, lactose, saccharose, as well as glucose-fructose syrups containing mixtures with different proportions of glucose, maltose, fructose, etc.

In the scope of the present invention, the apparent density is evaluated under conditions packed using an AutoTap™ device from the company Quantachrome. The principle is to measure the volume of a known mass of milk biscuits and to deduce the apparent density from it. To do this, seven milk biscuits are precisely weighed (PE in g), then covered with sand. It all is weighed again, then introduced into a cylindrical test piece and “packed” by mechanical vibrations (n=1000). At the end of this packing phase, reading the height of the test piece (V in ml) allows to calculate the density D of the milk biscuits, knowing the density of the sand (Ds in kg.m⁻³) and the quantity of sand (PS in g) added:

$$D = \frac{( PE \times \frac{Ds}{1000} )}{( ( V \times \frac{Ds}{1000} ) - PS )} \times 1000 \qquad [ Math 1 ]$$

By amylase compound, this means any raw material or ingredient comprising at least 60% of starch by weight. Starches are digestible complex carbohydrates composed of two types of molecules in variable proportion (amylose and amylopectin). The most common starch sources are cereal flours and, in particular, wheat. Other alternatives are also used such as: other cereal flours, refined or complete: rice, maize, oat, barley, spelt, small spelt, einkorn, triticale, etc.; pseudo-cereal flours (quinoa, amaranth and buckwheat) or leguminous flours (peas, lentils, beans, chickpeas); purified starches, obtained from flours after separation of protein and fibre fractions; flours and/or starches modified by physical, enzymatic and/or chemical treatments such as maltodextrins.

By baking powder, it is understood as substances, such as ammonium bicarbonate or mixtures of substances (of sodium, potassium or ammonium carbonate or bicarbonate type) and a weak acid (of tartaric acid or sodium pyrophosphate). On the regulatory level, these baking powders are additives in Europe and sometimes have limited dosing rates: sodium carbonates (E500 i, ii, iii), potassium carbonates (E501 i, ii), ammonium carbonates (E503 ii), magnesium carbonates (E504 i, ii), glucono-delta-lactone (E575), tartaric acid (E331), sodium tartrate (E335 i, ii), potassium tartrate (E336 i, ii), potassium sodium tartrate (E337), diphosphates or pyrophosphates (E450), alumino-sodic phosphate (E541) (source: SYFAB, Syndicat national des Fabricants de Produits intermédiaires pour boulangerie, pâtisserie et viennoiserie (National Syndicate of Manufacturers of Intermediate Products for Bakery, Pastry-making and Viennoiserie), http://www.syfab.fr/ActiviteDetails.aspx?act=122&lid =5&rid=267). Due to their gas production reaction during cooking, baking powders incorporated in the dough disappear totally (example of ammonium carbonates) or partially (case of other baking powders) during cooking. In the scope of this application, the baking powder contents optionally used corresponding to the values implemented in doughs and not to the residual concentration of so-called baking powders in the end product.

By emulsifier, it is understood as surfactant substances which, added to a foodstuff, allow to achieve or maintain the homogenous mixture of two or more non-miscible phases, such as oil and water. These are substances such as lecithin (E322), and families of mono- and diglycerides of fatty acids (E471) and esters of mono- and diglycerides of fatty acids (E472). As an example, in the category of E472s, lactic esters of mono- and diglycerides (E472b) can be mentioned, monoacetyltartaric and diacetyltartaric esters of the mono- and diglycerides of fatty acid (E472e) and mixed acetic and tartaric esters of mono- and diglycerides of fatty acid (E472f). Other possible emulsifiers are fatty acid sucroesters (E473), sucro-glycerides (E474), fatty acid polyglyceric esters (E475), glycol propylene esters (E477), stearoyl-2 sodium or calcium lactylate (E481, E482).

The Applicant has observed that these ingredients—amylase compounds, starch sources, maltodextrins, food fibres, polyols, baking powders and emulsifiers—were not necessary to the embodiment of the invention and to obtaining a milk biscuit having optimal organoleptic properties, it is therefore not considered to include them in the recipe of the milk powders according to the invention, in particular for nutritional reasons or also for obtaining a short list of ingredients with no additives; it is however clear that their possible addition would not affect the implementation of the invention.

According to particular embodiments, the milk biscuit according to the invention is such that it contains:
at least 90%, 95%, 98% or 100% by weight of proteins of milk origin with respect to the weight of total proteins; and/or
when the milk biscuit contains an ingredient of non-milk origin, the latter is preferably represented by plant proteins, or vegetable fat and/or saccharose or other equivalent sugary materials and or food fibres; and/or
between 20 and 85% preferably 35% to 75%, more preferably 40 to 65% by weight of the total weight of the milk biscuit of whole milk or skimmed milk powder; and/or
has an apparent density comprised between 0.1 and 0.4 g/cm³; 0.12 and 0.4 g/cm³; 0.15 and 0.4 g/cm³ and preferably between 0.1 and 0.35 g/cm³ or between 0.15 and 0.35 g/cm³; and/or
0.8 to 1.6% or 0.8 to 1.3% by weight of the total weight of the milk biscuit of calcium; and/or
less than 5%, preferably less than 3%, also preferably less than 1%, by weight of the total weight of the milk biscuit of amylase compound or other compound, even does not comprise any amylase compound; and/or
less than 0.5%, preferably less than 0.3% or less than 0.1% by weight of the total weight of the milk biscuit of at least one additive selected from among baking powders and emulsifiers.

According to another particular embodiment, the milk biscuit according to the invention is such that said mono- and/or disaccharides are lactose present in a quantity comprised between 12% to 40% or 12% to 30% by weight of the total weight of the milk biscuit; and said lipids are of milk origin.

According to a particular embodiment, the milk biscuit according to the invention does not comprise any additive selected from among baking powders and emulsifiers; preferably the milk biscuit according to the invention does not comprise any baking powder, nor emulsifier. According to one of these two preceding embodiments, the milk biscuit according to the invention does not further comprise any food additive selected from among: gellant (substances which, added to a foodstuff, give it consistency by forming a gel), thickener (substances which, added to a foodstuff, increase its viscosity), stabiliser (substances which, added to a foodstuff, allow to maintain its physico-chemical state), humectant (substances which prevent the drying of the foodstuffs by compensating for the effects of a low atmospheric humidity or which favour the dissolution of a powder in an aqueous medium), sequestering agent (substances which form chemical complexes with metal ions) and melting salts (substances which disperse the proteins contained in cheese, thus leading to a homogenous distribution of fats and other components). Among the substances in question, different carrageenans can be mentioned (iota, lambda, kappa), galactomannans (guar gums, carob, fenugreek, tara,), xanthan gum, pectins, modified starches, polyols, etc.

According to a particular embodiment, the milk biscuit according to the invention is constituted of:
30 to 50% by weight of the total weight of the milk biscuit of proteins, of which at least 80% is of milk origin;
12 to 45% by weight of the total weight of the milk biscuit of mono- and/or disaccharides, of which at least 60% by weight of said mono- and/or disaccharides is lactose;
2 to 40% by weight of the total weight of the milk biscuit of lipids;
0.8 to 1.3% by weight of the total weight of the milk biscuit of calcium;
less than 6% by weight of the total weight of the milk biscuit of water; said biscuit is such
that it comprises at least 60% by weight of the total weight of the milk biscuit of ingredients of milk origin; and
that it has an apparent density comprised between 0.1 and 0.6 g/cm³.

Advantageously, the high content of milk ingredient does not damage the structure and the texture of the biscuits according to the invention; on the contrary, the Applicant has achieved preparing biscuits having varied structures going from the hollow structure, totally or partially hollowed out, i.e. that their inside is constituted of one single cavity or of several wide cavities, with biscuits with a multitude of larger or smaller cavities which do not communicate together (foamy texture).

Surprisingly, the milk biscuit preparation does not require any significant adaptation of the industrial methods conventionally implemented in the biscuit sector; this has proved to be very advantageous economically since it is not necessary to invest in new equipment for producing milk biscuits of the invention.

This result is unexpected, as the obtaining of a product expanded via a rotary moulding machine is not clear for a biscuit-maker; indeed, in this type of method, the dough has a sandy and discontinuous structure, i.e. that it is presented in the form of a granular material, constituted of independent particles of variable size which, in the state, do not form a continuous structure which can be manipulated. It is therefore necessary to strongly compress these pressurised particles in the cylinder stamped to obtain a continuous piece of dough, but which remains fragile and not very cohesive. After forming, the pieces of dough are recovered on a belt and sent directly into the oven, without any additional manipulation, such as cutting or other. The strong compression in the rotary moulding machine gives the dough a high density (typically at least equal to 1.1 g/cm³), which penalises the development of the product in the oven. In addition, the quantity of water added in the case of sandy doughs is limited, therefore the vaporisation of the water is not a sufficient driver for generating the rising of the product. The technical solution conventionally used in biscuit-making therefore consists of using a sometimes significant quantity of baking powders (up to 1% by weight of the dough) so as to expand the product during cooking. In the case of the invention, even without using a leavening agent, an expansion is all the same observed despite the sandy, discontinuous structure of the dough and the strong compression in the rotary moulding machine.

In addition and always surprisingly, with the method of the invention, the dough compressed by the moulding generates under certain conditions, a hollow shell for cooking, which is not generally observed in cereal cooking products (which have a relatively homogenous multi-honeycomb inner structure).

There are other extrusion, blowing, popping, vacuum expansion type expansion technologies, but none of them leads to obtaining a hollow shell. The technologies for obtaining known shells are, on the one hand, cold moulding (chocolate, cold moulding type) or hot moulding (waffle type), but none of these technologies are applied to milk or cheese compositions of the invention. In addition, generally, moulding technologies require a first half-shell moulding phase which are then assembled to create the final shell. In the case of the invention, the shell is made in one single step.

Finally, the high lactose content of the milk biscuit is not advantageous, due to the low solubility of this sugar in water. Biscuit-makers traditionally use saccharose which has a high solubility (10 times greater than that of lactose), even inverted sugar syrups or glucose fructose syrups when they want to be ensured to implement dissolved sugars. The use of lactose in significant quantity therefore clearly goes against the experience of a person skilled in the art.

The present invention therefore also relates to a method for preparing a milk biscuit such as described above comprising, in particular, the steps of:
a—mixing ingredients for obtaining a dough; optionally, there is application of a waiting time from the preparation of the dough and before its forming;
b—forming the dough
c—cutting the dough;
d—optionally, pre-drying the cut dough; for example, the pre-drying in a chamber at controlled temperature and hygrometry between 50 and 70° C., 5 to 10% HR;
e—oven cooking;
f—optionally, drying until reaching the target humidity;
g—optionally, adding inclusions on the surface, spraying the surface, soaking in another fluid, like for example, melted chocolate or a similar chocolate, etc.

By “similar” chocolate, this means a product similar to chocolate, but where the cocoa butter is replaced with other fats, of plant or animal origin.

The forming and the cutting of the dough are carried out using usual equipment of the biscuit-making sector and known to a person skilled in the art; several tools are possible according to the appearance and the consistent of the dough, themselves according to the formula and to the hydration level (quantity of water added during kneading):

*in the case of a sandy, non-continuous dough (individual particles do not form any continuous network wherein pieces of dough can be cut), the forming can be carried out by a rotary moulding machine;
*in the case of a continuous dough which could be stretched, compressed and cut, the forming can be carried out by rolling into a thin layer then roto-cut if the dough is sufficiently firm or also compression in a volumetric cylinder and cutting using a wire cutter or an iris if the dough is more flexible. In the latter case, the use of a co-extrusion is also possible, which allows to have a fodder (or another dough) arranged inside the composition and this, concentrically. The composition according to the invention can be the inner or outer dough of a co-extruded product.

The milk biscuit obtained by the method according to the invention can of course then be packaged for its conservation and its transportation.

### EXAMPLES OF PREPARING MILK BISCUITS ACCORDING TO THE INVENTION

### 1—Formula Type I

Ingredients: Whole milk (35%), skimmed milk powder (29%), vegetable fat (14%), milk protein powder (12%), sugar (10%).

Nutritional composition:

TABLE 1

| | |
|---|---|
| Proteins | 31 g/100 g |
| Of which milk proteins | 31 g/100 g |
| Sugars | 41 g/100 g |
| Of which lactose | 26 g/100 g |
| Of which saccharose | 15 g/100 g |
| Lipids | 23 g/100 g |
| Of which milk lipids | 3 g/100 g |
| Of which plant lipids | 20 g/100 g |
| Starch | 0 g/100 g |
| Food fibres | 0 g/100 g |
| Calcium | 900 mg/100 g |
| Water | 3 g/100 g |

Characterisation of the product: product puffed in the form of a hollow cavity, crunchy and dispersant, with a milk taste. Apparent density according to the measuring protocol of 0.17 g/cm³. The dry skimmed milk and whole milk powder content in end products is 46% (respectively 40% and 6%).

### 2—Formula Type II

Ingredients: Parmesan (40%), skimmed milk powder (26.5%), water (22.7%), milk protein powder (10%), salt (0.8%).

Nutritional composition:

TABLE 2

| | |
|---|---|
| Proteins | 48 g/100 g |
| Of which milk proteins | 48 g/100 g |
| Sugars | 24 g/100 g |
| Of which lactose | 24 g/100 g |
| Lipids | 17 g/100 g |
| Of which milk lipids | 17 g/100 g |
| Starch | 0 g/100 g |
| Food fibres | 0 g/100 g |
| Calcium | 1400 mg/100 g |
| Water | 3 g/100 g |

Characterisation of the product: product puffed in the form of a hollow cavity, crunchy and dispersant, with a shaved parmesan taste. Apparent density according to the measuring protocol of 0.15 g/cm³. The end product contains 36% of skimmed milk powder.

### 3—Formula Type III

Ingredients: Skimmed milk powder (60%), water (28%), vegetable fat (10%), milk protein powder (2%).

Nutritional composition:

TABLE 3

| | |
|---|---|
| Proteins | 33 g/100 g |
| Of which milk proteins | 33 g/100 g |
| Sugars | 45 g/100 g |
| Of which lactose | 45 g/100 g |
| Lipids | 15 g/100 g |
| Of which milk lipids | 1 g/100 g |
| Of which plant lipids | 14 g/100 g |
| Starch | 0 g/100 g |
| Food fibres | 0 g/100 g |
| Calcium | 1100 mg/100 g |
| Water | 3 g/100 g |

Characterisation of the product: This product has a multi-honeycomb inner structure different from hollow shells from the preceding examples and has a sugary baked milk taste.

Apparent density according to the measuring protocol of 0.38 g/cm³. The end product contains 80% of skimmed milk powder.

### 4—Formula Type IV

Ingredients: Skimmed milk powder (46%), water (20%), vegetable fat (12%), sugar (10%), milk protein powder (7%), gluten (5%).

Nutritional composition:

TABLE 4

| | |
|---|---|
| Proteins | 33 g/100 g |
| Of which milk proteins | 28 g/100 g |
| Of which plant proteins | 5 g/100 g |
| Sugars | 44 g/100 g |
| Of which lactose | 32 g/100 g |
| Of which saccharose | 12 g/100 g |
| Lipids | 16 g/100 g |
| Of which milk lipids | 1 g/100 g |
| Of which plant lipids | 15 g/100 g |
| Starch | 0.3 g/100 g |
| Food fibres | 0 g/100 g |
| Calcium | 900 mg/100 g |
| Water | 3 g/100 g |

Characterisation of the product: product puffed in the form of a hollow cavity, crunchy and dispersant. Apparent density according to the measuring protocol of 0.18 g/cm³. The end product contains 55% of skimmed milk powder.

### 5—Formula Type V

Ingredients: Skimmed milk powder (30%), water (28%), milk protein powder (12%), vegetable fat (12%), sugar (10%), maize starch (6%).

Nutritional composition:

TABLE 5

| | |
|---|---|
| Proteins | 33 g/100 g |
| Of which milk proteins | 33 g/100 g |
| Sugars | 36 g/100 g |
| Of which lactose | 22 g/100 g |
| Of which saccharose | 14 g/100 g |
| Lipids | 18 g/100 g |
| Of which milk lipids | 1 g/100 g |
| Of which plant lipids | 17 g/100 g |
| Starch | 8 g/100 g |
| Food fibres | 0 g/100 g |
| Calcium | 900 mg/100 g |
| Water | 3 g/100 g |

Characterisation of the product: product puffed in the form of a hollow cavity, crunchy and dispersant. Apparent density according to the measuring protocol of 0.18 g/cm³. The end product contains 40% of skimmed milk powder.

### 6—Formula Type VI

Ingredients: Skimmed milk powder (41%), whole milk (30%), butter (16%), milk protein powder (13%).

Nutritional composition:

TABLE 6

| | |
|---|---|
| Proteins | 37 g/100 g |
| Of which milk proteins | 37 g/100 g |
| Sugars | 35 g/100 g |
| Of which lactose | 35 g/100 g |
| Lipids | 21 g/100 g |
| Of which milk lipids | 21 g/100 g |
| Starch | 0 g/100 g |
| Food fibres | 0 g/100 g |
| Calcium | 1100 mg/100 g |
| Water | 3 g/100 g |

Characterisation of the product: product puffed in the form of a hollow cavity, crunchy and dispersant. Apparent density according to the measuring protocol of 0.2 g/cm³. The end product only contains milk ingredients including 60% of skimmed milk powder.

### 7—Formula Type VII

Ingredients: Water (40%), skimmed milk powder (33.3%), milk protein powder (26.7%).

Nutritional composition:

TABLE 7

| | |
|---|---|
| Proteins | 57 g/100 g |
| Of which milk proteins | 57 g/100 g |
| Sugars | 35 g/100 g |
| Of which lactose | 35 g/100 g |
| Lipids | 1.5 g/100 g |
| Of which milk lipids | 1.5 g/100 g |
| Starch | 0 g/100 g |
| Food fibres | 0 g/100 g |
| Calcium | 1600 mg/100 g |
| Water | 3 g/100 g |

Characterisation of the product: product very puffed in the form of a hollow cavity, crunchy and dispersant. Apparent density according to the measuring protocol of 0.12 g/cm³. The end product only contains milk ingredients, including 54% of skimmed milk powder. It contains no added fat.

### 8—Formula Type VIII

Ingredients: Skimmed milk powder (46%), water (30%), milk protein powder (10%), butter (10%), FOS (7%).

Nutritional composition:

TABLE 8

| | |
|---|---|
| Proteins | 35 g/100 g |
| Of which milk proteins | 35 g/100 g |
| Sugars | 37 g/100 g |
| Of which lactose | 36 g/100 g |
| Of which other sugars | 1 g/100 g |
| coming from FOSs | |
| Lipids | 13 g/100 g |
| Of which milk lipids | 13 g/100 g |
| Starch | 0 g/100 g |
| Food fibres | 9 g/100 g |
| Calcium | 1100 mg/100 g |
| Water | 3 g/100 g |

Characterisation of the product: product puffed in the form of a hollow cavity, crunchy and dispersant. Apparent density according to the measuring protocol of 0.26 g/cm³. The end product contains 62% of skimmed milk powder.

### Summary of the Composition of Biscuits According to Examples I to VIII

| | Ex 1 | Ex 2 | Ex 3 | Ex 4 | Ex 5 | Ex 6 | Ex 7 | Ex 8 |
|---|---|---|---|---|---|---|---|---|
| Total protein | 31% | 48% | 33% | 33% | 33% | 37% | 57% | 35% |
| content (g/100 g end | | | | | | | | |
| product) | | | | | | | | |
| Milk protein | 31% | 48% | 33% | 28% | 33% | 37% | 57% | 35% |
| content (g/100 g end | | | | | | | | |
| product) | | | | | | | | |
| % of milk proteins out | 100% | 100% | 100% | 85% | 100% | 100% | 100% | 100% |
| of total proteins | | | | | | | | |
| Sugar content (g/100 g | 41% | 24% | 45% | 44% | 36% | 35% | 35% | 37% |
| end product) | | | | | | | | |
| Lactose content (g/100 g | 26% | 24% | 45% | 32% | 22% | 35% | 35% | 36% |
| end product) | | | | | | | | |
| % of lactose out of total | 64% | 100% | 100% | 71% | 61% | 100% | 100% | 99% |
| sugars | | | | | | | | |
| Lipid content (g/100 g | 23% | 17% | 15% | 16% | 18% | 21% | 1.5% | 13% |
| end product) | | | | | | | | |
| Ponderal content of milk | 64% | 99% | 85% | 65% | 60% | 100% | 100% | 90% |
| ingredients on dry end | | | | | | | | |
| product | | | | | | | | |
| Starch content (g/100 g | 0% | 0% | 0% | 0.3% | 8% | 0% | 0% | 0% |
| end product) | | | | | | | | |
| Whole or skimmed milk | 46% | 36% | 80% | 55% | 40% | 60% | 54% | 62% |
| powder content on end | | | | | | | | |
| product | | | | | | | | |
| Fibre content (g/100 g | 0% | 0% | 0% | 0% | 0% | 0% | 0% | 9% |
| end product) | | | | | | | | |
| Ca content (mg/100 g | 900 | 1400 | 1100 | 900 | 900 | 1100 | 1600 | 1100 |
| end product) | | | | | | | | |

1. A milk biscuit comprising:
30 to 60% by weight of the total weight of the milk biscuit of proteins, of which at least 80% is of milk origin;
12 to 45% by weight of the total weight of the milk biscuit of mono- and/or disaccharides, of which at least 60% by weight of said mono- and/or disaccharides is lactose;
1 to 40% by weight of the total weight of the milk biscuit of lipids; and
less than 6% by weight of the total weight of the milk biscuit of water.

2. The milk biscuit according to claim 1, wherein the milk biscuit comprises at least 60% by weight of the total weight of the milk biscuit comprises ingredients of milk origin.

3. The milk biscuit according to claim 1, wherein the milk biscuit has an apparent density between 0.1 and 0.6 g/cm³.

4. The milk biscuit according to claim 1, further comprising less than 10% by weight of the total weight of the milk biscuit of any compound other than proteins, mono- and/or disaccharides, lipids and water.

5. The milk biscuit according to claim 1, further comprising less than 1% by weight of the total weight of the milk biscuit of at least one additive selected from among baking powders and emulsifiers.

6. (canceled)

7. The milk biscuit according to claim 6, wherein the milk biscuit:
comprises at least 60% by weight of the total weight of the milk biscuit of ingredients of milk origin; and/or
has an apparent density comprised between 0.1 and 0.6 g/cm³.

8. The milk biscuit according claim 1, further comprising between 20 and 85% by weight of the total weight of the milk biscuit of whole or skimmed milk.

9. The milk biscuit according to claim 1, wherein the lipids comprise vegetable fat.

10. The milk biscuit according to claim 1, wherein the milk biscuit has an apparent density between 0.12 and 0.4 g/cm³.

11. The milk biscuit according to claim 1, further comprising 0.8 to 1.6% by weight of the total weight of the milk biscuit of calcium.

12. The milk biscuit according to claim 1, further comprising:
less than 5% by weight of the total weight of the milk biscuit of any other compounds, other than proteins, mono- and/or disaccharides, lipids and water; and/or
less than 0.5% by weight of the total weight of the milk biscuit of at least one additive selected from among baking powders and emulsifiers.

13. The milk biscuit according to claim 1, wherein:
the mono- and/or disaccharides are lactose present in a quantity comprised between 12% and 40% by weight of the total weight of the milk biscuit; and
wherein the lipids are of milk origin.

14. The milk biscuit according to claim 1, wherein the milk biscuit does not comprise at least one additive selected from among baking powders and emulsifiers.

15. A method for preparing a milk biscuit according to claim 1, the method comprising:
mixing ingredients for obtaining a dough;
forming the dough;
cutting the dough; and
oven cooking the dough.

16. The method of claim 15, wherein the method further comprises pre-drying the cut dough before oven cooking.

17. The method of claim 15, wherein the method further comprises drying the dough to a target humidity.

18. The method of claim 15, wherein the method further comprises:
adding inclusions on a surface of the dough; and
spraying the surface; and soaking the dough in another fluid.

19. The method of claim 18, wherein the fluid is a chocolate or melted chocolate.
